(19) United States
(12) Patent Application Publication
(10) Pub. No.: US 2010/0004405 A1
(43) Pub. Date: Jan. 7, 2010

(54) Organic compound and process for inhibiting corrosion on metals

(76) Inventor: Anil Kelkar, Pune (IN)

Correspondence Address: LADAS & PARRY LLP, 26 WEST 61ST STREET, NEW YORK, NY, 10023, US

(21) Appl. No.: 11/920,202

(22) PCT Filed: Oct. 20, 2005
(86) PCT No.: PCT/IN2005/000342

§ 371 Date: Sep. 18, 2009

(30) Foreign Application Priority Data
May 13, 2005 (IN) 581/MUM/2005

(51) Int. Cl. C07F 9/09; C08L 79/00

(52) U.S. Cl. 525/418; 558/177

(57) ABSTRACT

A process for inhibiting corrosion on metals comprises providing a metal surface to be protected and applying to said surface a protective organic compound, the said organic compound being formed by reacting an alcohol phosphate ester, multi-esters below C16 chain length, any petroleum solvent and/or its derivative, any fatty amines and/or its block polymer and a coupling agent, standard additives for colour and odour maintenance and the said process being carried out at a temperature between 30 deg C. and 180 deg C. and obtaining a homogenous and biodegradable mass to form an organic compound to reduce corrosion and reduce metal loss.

### TECHNICAL FIELD OF THE INVENTION

The present invention is a process to prepare an organic compound to reduce corrosion on metal surface and the compound obtained there-from. The present invention is a process which displaces primary embedded corrosion, dehydrates water and donates antistatic properties by forming a compact corrosion film with chemi-adsorbed organic compound bond to reduce the rate of corrosion at a very low cost.

### BACKGROUND OF THE INVENTION

Any metal article, produced or manufactured, always has primary embedded corrosion being integral to the environment, f the metal surface. This primary embedded corrosion creates an environment, which is conducive to the growth of corrosion rate.

Primary surface oxide i.e. Iron oxide is present on the metal surfaces even at the time of manufacturing. This primary surface oxide can be classified into saturated and unsaturated oxide. Any metal when manufactured has primary embedded corrosion due to this saturated oxide. For example, construction steel like rebar used in reinforced cement concrete, when manufactured by any process, has embedded corrosion on the surface. The unsaturated oxide is responsible for growth of corrosion on metal and its alloys. Being unsaturated it does not require any additional donor from the environment, as the donor exist on the metal itself. Exposure to industrial environment, storage, transportation etc. lead to further growth of metal oxidation and corrosion. This increased corrosion and metal oxidation leads to loss of metal, dimension control and surfaced quality requirements of the ferrous material.

There is neither any standard method available to remove the unsaturated oxide nor any method that quarantines such unsaturated oxides so as to selectively control the growth rate of metal loss due to unsaturated oxides.

It is therefore the object of the present invention to selectively control and reduce the rate of corrosion by quarantining such unsaturated oxides from the metal surfaces.

The present invention, therefore, displaces primary embedded corrosion, dehydrates water from the unsaturated oxide and donates anti static properties to reduce the rate of corrosion.

### PRIOR ART

In prior art there exist no processes or methods that selectively deal with the removal of the unsaturated oxides from metal surface to stop further corrosion growth rate and metal loss. Nonetheless there are various methods that deal with the removal of corrosion by varied means.

References:
1. NATCO Group publication.
2. U.S. Pat. No. 61,370
3. DE3828489—Process for producing corrosion-inhibiting oxide layers

NATCO Group Publication:

In aqueous systems, there are two basic ways to inhibit corrosion:
Remove the corrosive oxygen from the water, either by mechanical or chemical de-aeration.
Add corrosion inhibitors.

Corrosion Inhibitors

A corrosion inhibitor is any substance, which effectively decreases the corrosion rate when added to an environment.
Passivating (anodic) inhibitors form a protective oxide film on the metal surface. They are the best inhibitors because they can be used in economical concentrations, and their protective films are tenacious and tend to be rapidly repaired if damaged.
Precipitating (cathodic) inhibitors are simply chemicals which form insoluble precipitates that can coat and protect the surface

Adsorption inhibitors have polar properties, which cause them to be adsorbed on the surface of the metal. They are usually organic materials.

Passivation Inhibitors

Examples of passivators (anodic inhibitors) include chromate, nitrite, molybdate, and orthophosphate. All are oxidizers and promote passivation by increasing the electrical potential of the iron. Chromate and nitrite do not require oxygen and thus can be effective.

Precipitating Inhibitors

Orthophosphate is a good example of a precipitating inhibitor, which exhibits a dual mechanism, acting as both an anodic passivator and a cathodic precipitator.

Copper Corrosion Inhibitors

The most effective corrosion inhibitors for copper and its alloys are the aromatic triazoles, such as benzotriazole (BZT) and tolyltriazole (TTA). These compounds bond directly with cuprous oxide at the metal surface, forming a “chemisorbed” film.

Adsorbtion Inhibitors

Adsorption inhibitors must have polar properties in order to be adsorbed, such as amines. Often, these molecules have dual functionality. They contain a hydrophilic group, which adsorbs onto the metal surface and an opposing hydrophobic group, which prevents further wetting of the metal.

Silicates

For many years, silicates have been used to inhibit aqueous corrosion, particularly in potable water systems. Their mechanism of inhibition has not yet been firmly established. They appear to inhibit by an adsorption mechanism. Silicates are slow-acting inhibitors, in some cases, 2 or 3 weeks may be required to establish protection fully.

U.S. Pat. No. 61,370

In yet another prior art, Corrosion of ferrous metal and aluminum surfaces, in particular, is inhibited by a layer of an organic-metallic complex of a polyamine with a (i) metal oxide, or (ii) metallate ion, or (iii) water-soluble metallate salt, in aqueous systems having a pH greater than about 7. The polyamine contains at least four (4) amine groups, two of which are secondary amine groups. The effect of the N atoms stretched over the length of the polyamine produces a “caging effect”0 which immobilizes the oxide, or metallate ions, thus forming the protective layer. The organic-metallic complex deposited on the metal's surface forms the “amine-metallic” layer, which may be either an “amine-metal oxide complex” which is a coordination complex, or, an “amine-metallate complex”. The amine-metallate complex may be either an ionic complex of “amine metallate ions”, or, a mixture of the polyamine and metallate salt which mixture is not a complex, but in solution, behaves like one, and is therefore referred to as an admixture complex of an “amine+metallate salt”. The organic-metallic complex may be present in a concentration from about 10 ppm to about 5% by wt in neutral or basic aqueous solution. In the lower range of this conc. up to about 2000 ppm, the complex is useful in aqueous process streams; in the higher range, from 2000 ppm to 5%, for a rinse for phosphated metal parts, in lieu of a conventional chromate rinse.

DE3828489

This invention relates to a process for producing corrosion-inhibiting oxide layers on surfaces of structural elements consisting of steels or nickel-based alloys by hot-water oxidation of the structural elements for several hours in an aqueous medium, in particular for suppression of the radioactive contamination of the inside surfaces of primary circuits of water-cooled nuclear reactors. The object according to the invention is achieved in such a way that at least hydrated oxides, known per se, of metals of subgroup IV of the periodic table of the elements are released in the aqueous solution and the concentration of the metal compounds, which lead to the formation of these hydrated oxides, does not exceed the order of magnitude of 1 mu mol/l. It has been found that the hydrated oxides of extremely low solubility of some metals, above all of titanium and zirconium, in a particle size of less than 10 nm act as crystallization nuclei during the formation of the protective layer. They are also capable of penetrating into pores, which may already be present, having diameters of from 10 to 100 nm. The protection becomes effective in a total quantity, specific to unit area, of foreign metals in the order of magnitude from 0.1 g/m<2>, i.e. at only about 1/100 of the quantity hitherto used.

### DRAWBACKS IN PRIOR ART

1. No standard method and compound available to remove the unsaturated oxide so as to arrest or control the growth rate of metal loss and corrosion.
2. The corrosion control or rust preventive oils do not attempt to quarantine the unsaturated oxide.
3. Films or layers formed on metal surface are more than 1 micron in thickness.
4. Quantity of the rust preventive oils to be applied is considerably more resulting in increase of costs.
5. As the unsaturated oxide is not-quarantined the rate of corrosion restarts immediately thereby requiring repetitive treatment of the entire process of application at very less time intervals.
6. The methods or processes are curative rather than preventive in nature.

Object of the present invention, therefore, is removing the drawbacks or the deficiencies of the prior art thereby reducing the growth rate of corrosion and metal loss which is due to the primary oxide which forms at the time of manufacturing on the ferrous metal and its alloys.

Yet another object of the present invention is to develop a monolayer non-porous film of less than 1 micron with chemi-adsorbed organic compound bond to reduce the rate of corrosion at low very cost.

The foregoing objects of the invention are accomplished and the problems and shortcomings associated with prior art techniques and approaches are overcome by the present invention to reduce corrosion and prevent further metal loss.

Thus, it is the object of the present invention to dewater the metal surface, i.e. to remove the water of crystallization from the unsaturated oxides as such water of crystallization that inhibits ionization.

It is also the object of the present invention to modify the crystal structure of unsaturated oxide, which in effect quarantines the unsaturated oxide for preventing subsequent growth rate of metal loss. This can be achieved only if chemical is donated to the metal surface by chemi-adsorption.

A better and more complete understanding of the invention may be garnered from the detailed description of the preferred embodiment of the best mode of the invention as contemplated by the inventor.

### DESCRIPTION OF THE PREFERRED EMBODIMENT

In the preferred embodiment an organic compound is formed by a novel process comprising ascertaining the thickness of the layer of corrosion, selecting and mixing specific chemicals to give a synergistic effect so as to displace the primary embedded corrosion and modify the crystal structure of the unsaturated oxide by chemi-adsorption.

The present invention does not give an additional film that can be measured in microns but the collapse of the oxide cavity due to loss of water of crysallization results in reduction of corrosion.

Saturated and Unsaturated oxides do not change its percentage on the surface of the metal but the draining of their water of crystallization accompanied by the change of the crystal structure results in the decrease in the rate of corrosion.

This modification of the crystal structure makes the oxides softer than their original form thereby loosing their anchoring on the metal surfaces.

The present invention therefore is a process to prepare an organic compound comprising mixing of:
a) an alcohol phosphate ester, a polymer below C16 chain length which acts as a crystal modifier; and
b) any petroleum solvent or its derivative, to give dehydration property; and
c) any fatty amines or its block polymer to give antistatic/high wetting property;
d) a coupling agent (depending on the product used) is used not only to create a homogenous mass but also enables confirmation as to whether the resulting compound is biodegradable or not; and
e) Lanoline, to ensure adequate de-watering property (known as top dose modifier) in case the resulting compound does not have sufficient wetting properties; and
f) standard additives for colour and odour maintenance;

the said process being carried out at a temperature between 30 deg C. and 180 deg C.;

obtaining a homogenous and biodegradable mass to form a compound and the compound resulting there-from to give synergistic effect.

The quantity of the compound so obtained and to be applied depends upon the thickness of the unsaturated oxide present on the metal surface. Depending on the application or the metal and the thickness of the oxide different solvent blends and different coupling agents can be used. Use of Lanoline also helps as a dewatering agent.

The formation of a homogenous and a bio degradable mass is a preferred embodiment of the present invention.

Working or Effect of the Present Invention

The organic compound when applied to metal surfaces brings about the following:
a) Dehydration of water of crystallization from unsaturated oxides,
b) Modification of crystal structures of such unsaturated oxides thereby quarantining the oxide and making it docile,
c) Donating antistatic properties.

The unsaturated oxide has empty cavities holding water of crystallization as well as air pockets. On application of the said organic compound the unsaturated oxide looses its water of crystallization and its crystal structure gets modified.

The modified crystal structure of the unsaturated oxide, now being softer, collapses these empty cavities so as to form a mono film as a result of which the mother metal is isolated from the environmental donors such as oxygen, sulphor dioxide, Nitrogen, Carbon dioxide etc. Thus the unsaturated oxide gets quarantined, i.e. now there would be very limited scope for increase or decrease of oxide percentage.

Due to softer oxide conversion, the processing on metal surfaces becomes easier. The presence of high wetting properties forms a monolayer non-porous film, which is a milli-micron film, i.e., less than 1 micron, on the metal surface.

This helps in isolating embedded unsaturated oxides. Thus the process creates residual film thickness below 1 micron.

The process thus does not generate any anti-rust preventive film but the result is that the unsaturated oxide, which is embedded to the mother metal is made docile and it disassociates from the anchoring position and hence no external non-porous film is created.

The monolayer film itself develops anti-rust properties, which is not the same as applying an external layer like the anti-corrosive oils available in prior art. Thus it is an object of the present invention not to apply an external layer of any rust preventive oils as in prior art but to create a non-porous film, which is a result of the application of the present invention.

The quantity of the ingredients of the organic compound, obtained by the aforesaid process will depend upon the thickness of the unsaturated oxide on the metal surface to which the application is to be made.

Due to high wetting properties of the said organic compound, the mili micron cavities can be easily penetrated. Hence this reduces the quantity of the organic compound required to be applied on the metal surface or minimizes the number of treatments to-be made thereon.

Statement of the Invention:

The present invention therefore comprises:

A process for inhibiting corrosion on metals comprising:

Providing a metal surface to be protected;

Applying to said surface a protective organic compound, the said organic compound being formed by reacting:

an alcohol phosphate ester and multi-esters below C16 chain length; and

any petroleum solvent and/or its derivative; and

any fatty amines and/or its block polymer; and

a coupling agent; and

standard additives for colour and odour maintenance.

The said process is carried out at a temperature between 30 deg C. and 180 deg C. A homogenous and biodegradable mass is obtained to form an organic compound to reduce corrosion and reduce metal loss.

The quantity of the said solvents is at least 50 % with a maximum of 90% of the entire mixture, the proportion of the said alcohol phosphate ester and multi-esters and fatty amines and/or its block polymer being in the ratio 9:1 out of the remaining mixture. The said alcohol phosphate ester, may be selected from a group consisting mono, di, tri, esters derived from carbon chain below C16.

The said petroleum solvents and/or its derivatives are kerosene, mineral turpentine and/or its modified derivatives. The coupling agent may be selected from a group consisting of Lanolin, esters. The metal surface can be ferrous metals or its alloys. The said fatty amine derivative is used as a preservative. The said Lanoline is also used as a dewatering agent to enhance adequate de-watering properties.

The thickness of the oxide layer is measured by means of a magnetic gauge.

The said coupling agent enhances the biodegradability of the compound.

An organic compound is obtained from the aforesaid process. A method of treating the metal surface with an effective and optimum corrosion-inhibiting amount of the said organic compound.

The formation of the modified crystal structure quarantines the unsaturated oxide. The quarantined unsaturated oxide forms a non-porous monolayer film on the metal surface. The thickness of the monolayer film is less than 1 micron. Further the said residual monolayer film has wetting properties.

Example:

To illustrate the working of the present invention we are citing the following example. This example is just indicative and, should not be considered to limiting to this example. The applications would vary according to the specific characteristics of the metal and thus this example cannot be construed to be exhaustive.

Test Method and Equipments Used:
Test method used for cursory testing of each sample made is ASTM D-130 (which shows surface colour change so as to know the crystal structure has changed.
Magnetic coat gauge is used to measure (saturated and unsaturated) oxide layer on the metal surface.
Standard M.S. grade metal plates are used.
Humidifier is used for environment testing.

Experiment:

Three standard M.S. grade plates and three plates treated by spray method with excess drained from surface are kept for reaction for 24 hours at room temperature to get reddish colour change to gray or blackish colour.

Before treatment of two sets of metal plates Blank reading is taken by magnetic coat gauge. And after treatment also reading is taken. Then these two sets of treated and blank plates are kept in humidity chamber for one week and then for one week in open atmosphere for atmospheric corrosion donors.

Such six cycles are executed for reading.

Results:

1st Cycle:

| | original | Cycles | % growth of | % surface |
|---|---|---|---|---|
| Type of | micron | Micron oxide | oxide w.r.t | area |
| Sample | Oxide | thickness | Std. Blank plate | covered |
| Blank | 20 microns | 40 microns | 200% | 10% |
| sample | | | | |
| Treated | 5 microns | 10 microns | −200% | 5% |
| sample | | | | |

2nd Cycle:

| | original | Cycles | % growth of | % surface |
|---|---|---|---|---|
| Type of | micron | Micron oxide | oxide w.r.t | area |
| Sample | Oxide | thickness | Std. Blank plate | covered |
| Blank | 40 microns | 50 microns | 250% | 35% |
| sample | | | | |
| Treated | 10 microns | 15 microns | −125% | 7% |
| sample | | | | |

3rd Cycle:

| | original | Cycles | % growth of | % surface |
|---|---|---|---|---|
| Type of | micron | Micron oxide | oxide w.r.t. | area |
| Sample | Oxide | thickness | Std. Blank plate | covered |
| Blank | 50 microns | 60 microns | 300% | 35% |
| sample | | | | |
| Treated | 15 microns | 20 microns | 0% | 7% |
| sample | | | | |

The formation of the modified crystal structure quarantines the unsaturated oxide. The quarantined unsaturated oxide forms a non-porous monolayer film on the metal surface. The thickness of the monolayer film is less than 1 micron. Further the said residual monolayer film has wetting properties.

Example:

To illustrate the working of the present invention we are citing the following example. This example is just indicative and should not be considered to limiting to this example. The applications would vary according to the specific characteristics of the metal and thus this example cannot be construed to be exhaustive.

Test Method and Equipments Used:
Test method used for cursory testing of each sample made is ASTM D-130 (which shows surface colour change so as to know the crystal structure has changed.
Magnetic coat gauge is used to measure (saturated and unsaturated) oxide layer on the metal surface.
Standard M.S. grade metal plates are used.
Humidifier is used for environment testing.

Experiment:

Three standard M.S. grade plates and three plates treated by spray method with excess drained from surface are kept for reaction for 24 hours at room temperature to get reddish colour change to gray or blackish colour.

Before treatment of two sets of metal plates Blank reading is taken by magnetic coat gauge. And after treatment also reading is taken. Then these two sets of treated and blank plates are kept in humidity chamber for one week and then for one week in open atmosphere for atmospheric corrosion donors.

Conclusion:

Reading in growth rate of corrosion is stopped at 6^{th} cycle as standard blank sample covered 90% of the surface area. This result shows rate of corrosion is reduced by minimum 70% when said treatment is repeated 5 times.

The actual growth rate of treated plate as compared with blank plate comes to 14.2%.

Advantages:
The unsaturated oxide is quarantined, whereby there is no increase or decrease of oxide percentage.
Due to softer oxide conversion, the processing on metal surfaces becomes easier.
A residual mili-micron film, i.e. below 1 micron, on-metal surface is formed that helps in isolating embedded unsaturated oxides.
The invention in the form of the compound can be used as a transit protector (shop primer).
It dissociates unsaturated oxide molecules, which is easier to remove than those, which are embedded.
The formation of a monolayer film that is less than 1-micron with high wetting properties of the compound reduces the quantity of the compound to be applied. This makes the product significantly cost effective.

1. A process for inhibiting corrosion on metals comprising:
providing a metal surface to be protected;
applying to said surface a protective organic compound, the sad organic compound being formed by reacting:
a. an alcohol phosphate ester and multi-esters below C16 chain length;
b. any petroleum solvent and/or its derivative;
c. any fatty amines and/or its block polymer;
d. a coupling agent; and
e. standard additives for color and odor maintenance;
the said process being carried out at a temperature between 30° C. and 180° C.; and obtaining a homogenous and biodegradable mass to form an organic compound to reduce corrosion and reduce metal loss.

2. The process as claimed in claim 1, wherein the quantity of the solvents is at least 50% with a maximum of 90% of the entire mixture, the proportion of the said alcohol phosphate ester and multi-esters and fatty amines and/or its block polymer being in the ratio 9:1 out of the remaining mixture.

3. The process as claimed in claim 1, wherein the alcohol phosphate ester, may be selected from a group consisting mono, di, tri, esters derived from carbon chain below C16.

4. The process as claimed in claim 1, wherein the petroleum solvents and/or its derivatives are kerosene, mineral turpentine and/or its modified derivatives.

5. The process as claimed in claim 1, wherein the coupling agent may be selected from a group consisting of Lanolin, esters.

6. A The process as claimed in claim 1, wherein the said metal surface can be ferrous metals or an alloy thereof.

7. The A process as claimed in claim 1, wherein the said fatty amine derivative is used as a preservative.

8. The process as claimed in claim 1, further comprising lanoline as a de-watering agent.

9. The process as claimed in claim 1, wherein the thickness of the oxide layer is measured by means of a magnetic gauge.

10. The process as claimed in claim 1, wherein the said coupling agent enhances the bio-degradability of the compound.

11. An organic compound obtained from the process of claim 1.

12. A method of treating the metal surface with an effective and optimum corrosion-inhibiting amount of the organic compound as claimed in claim 11.

13. An organic compound obtained from the process of claim 1, wherein the formation of the modified crystal structure quarantines the unsaturated Oxide.

14. An organic compound obtained from the process of claim 1, wherein the quarantined unsaturated oxide forms a non-porous monolayer film on the metal surface.

15. An organic compound as claimed in claim 11, wherein the thickness of the monolayer film is less than 1 micron.

16. An organic compound as claimed in claim 11, wherein the said residual onolayer film has wetting properties.

17. (canceled)
